(19) United States
(12) Patent Application Publication
(10) Pub. No.: US 2006/0099349 A1
(43) Pub. Date: May 11, 2006

(54) Method of coating metallic substrates with oxidizing materials by means of electric-arc wire spraying

(76) Inventors: Axel Heuberger, Wildberg (DE); Wolfgang Pellkofer, Herrieden (DE); Alexander Sagel, Plochingen (DE); Oliver Storz, Altbach (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/197,486

(22) Filed: Aug. 5, 2005

Related U.S. Application Data
(63) Continuation of application No. 10/954,365, filed on Oct. 1, 2004.

(30) Foreign Application Priority Data
Oct. 2, 2003 (DE) 103 45 827.1

(51) Int. Cl. B05D 1/08

(52) U.S. Cl. 427/446

(57) ABSTRACT

Al, Ti, and/or Si oxide/nitride coating of metallic substrates in friction systems is performed by arc wire spraying.

This application is a continuation of U.S. patent application Ser. No. 10/954,365, filed Oct. 1, 2004, the entire disclosure of which is incorporated by reference herein.

This application also claims the priority of German application 103 45 827.1, filed Oct. 2, 2003.

### BACKGROUND AND SUMMARY OF THE INVENTION

This invention relates to a method of coating substrates by means of arc wire spraying. Generally, arc wire spraying is part of the field of thermal spraying and synonymously is called wire spraying. According to the prior art, adhesion-promoting layers can be applied to cylinder liners by arc wire spraying (DaimlerChrysler, German Patent Document DE 100 02 440 A1). In German Patent Document DE 201 21 680 U1, it is described that elevations on surfaces of supporting metal sheets can be generated by air wire spraying.

It is an object of the present invention to provide a method of coating metallic substrates by arc wire spraying. According to the invention, metallic substrates, specifically consisting of a pure metal or of a composition of at least two metals AₓB_{y} (for example, alloys) or of a mechanical metal mixture, are preferred. Those metallic substrates are particularly preferred which are the object of friction systems such as cylinder working paths or bearings.

It is therefore another object of the present invention to improve the tribological behavior in friction systems by providing selected coatings on a metallic substrate. It was found that, as a result of the efficiently applied coating, a reduction of friction in the friction system is produced by the efficient arc wire spraying.

### BRIEF DESCRIPTION OF THE DRAWING FIGURE

FIG. 1 is a schematic illustration of wires used for production of their oxides and nitrides in corresponding gases.

### DETAILED DESCRIPTION OF THE INVENTION

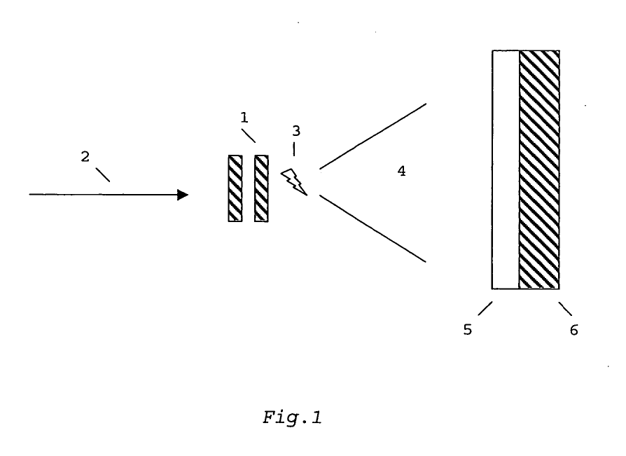

The principle of arc wire spraying is utilized within the scope of the invention: Two or more wires (1) of different polarities, applied by direct voltage or alternating voltage, are contacted while forming an arc (3). At temperatures of from 2,000 to 5,000 K, a continuously guided wire containing an oxidizable material will melt, and the resulting molten path is finely atomized in the plasma (4) by means of a gas current (2). The resulting material particles (4) arrive on the substrate (6) at high velocities while forming a coating of the substrate (5) (see FIG. 1).

According to the invention, oxidizing materials are used, preferably metals of the third, fourth or fifth period in the Periodic System of Elements; however, metals with a high tendency to form oxides, such as titanium, aluminum or silicon, preferably of a chemical stability and ductility, as exist, for example, in ceramic systems, are particularly preferable. Likewise, metal nitrides are of interest according to the invention.

According to the invention, such metal oxides and metal nitrides preferably form coatings while forming stable phases in the metallic substrate.

Corresponding wires consisting of the oxidizing material are used in arc wire spraying, for example, pure titanium, aluminum or silicon wires, or, as required, wires containing metal mixtures or metal compositions (for example, alloys). According to the invention, various wires of this type can be used simultaneously in arc wire spraying. Other suitable metals are not excluded. The wires are used for the production of their oxides and nitrides in corresponding gases (see FIG. 1). Wires made of titanium and/or aluminum are therefore suitable which are exposed to a gas current consisting of pure nitrogen and/or pure oxygen or a mixture thereof, or possibly air, while forming a suitable plasma. For increasing the collision rate, inert gases, such as xenon can also be used. Within the framework of the arc wire spraying, material particles are formed in the plasma—charged or uncharged—consisting of titanium oxide(s) or titanium nitride(s), corresponding (radical) ions and/or of aluminum oxide(s) or aluminum nitride(s), and/or of silicon oxide(s) and/or silicon nitride(s), corresponding (radical) ions. In a special embodiment, the coating is a ceramic layer which, according to the invention, is provided by corresponding metal oxides by means of arc wire spraying.

By varying the parameters of the arc wire spraying (temperature, gas current, particle velocity, selection of the wire thickness, suitability and processing of the substrate), the person skilled in the art is capable of creating a corresponding layer thickness and a suitable quality (measuring of the frictional behavior under mechanical stress).

The above-mentioned tasks are therefore achieved by a method of producing coatings on a metallic substrate by means of arc wire spraying, in which the layer consists primarily (that is, in a quantitative sense) of aluminum oxide and/or aluminum nitride and/or titanium oxide and/or titanium nitride and/or silicon oxide and/or silicon nitride or is a mixture thereof and, optionally, secondarily (with respect to the quantity) contains metal oxides or metal nitrides (for example, as a result of contamination or tarnish. “Primarily” also indicates that at least one aluminum oxide and/or aluminum nitride and/or titanium oxide and/or titanium nitride and/or silicon oxide and/or silicon nitride is primarily (in a quantitative sense) present, namely produced by the arc wire spraying in the process according to the invention.

Within the scope of this invention, a mixture can also be understood to relate to oxidic or nitridic mixed phases of these metals. Likewise, an intermetallic bonding of the layer with the metallic substrate cannot be excluded which, in turn, intervenes in the structure of the layer (for example, also while forming mixed phases with the metallic substrate).

In friction systems, such as, for example, in cylinder working paths, the achieved coatings consisting of the above-mentioned oxides and nitrides or the ceramic layer have a high resistance to wear. This leads to an advantageous reduction of the drag power and thus to a reduction of the fuel consumption.

It is therefore another object of the invention that the layer is a wear protection layer, preferably in a friction system.

In a further embodiment of the invention, it was also found to be advantageous to achieve a high cooling rate of the particles by means of a cooling by known methods, which high cooling rate is particularly advantageous for the production of suitable ceramic layers.

In another preferred embodiment, the method is implemented in a continuous and automated manner. In this case, the above-mentioned wires are continuously fed into the process. By means of moved substrates, new substrates are continuously coated. The control takes place in a computer-operated manner.

We claim:

1. A method of producing a coating on a metallic substrate comprising providing the coating by arc wire spraying of at least one of aluminum nitride, aluminum oxide, titanium nitride, titanium oxide, silicon oxide, and silicon nitride.

2. The method according to claim 1, wherein at least one oxide or nitride is primary, and wherein other metal oxides or metal nitrides are secondary.

3. The method according to claim 1, wherein the coating is produced as a ceramic layer.

4. The method according to claim 1, wherein the layer is produced as a protection layer protecting against wear.

5. The method according to claim 1, wherein the metallic substrate is the object of a friction system.

6. The method according to claim 1, wherein the metallic substrate is a cylinder working path or a bearing.

7. A layer obtainable by a method according to claim 1.

8. A metallic substrate having a coating produced according to claim 1.

9. The method according to claim 2, wherein the coating is produced as a ceramic layer.

10. The method according to claim 2, wherein the layer is produced as a protection layer protecting against wear.

11. The method according to claim 3, wherein the layer is produced as a protection layer protecting against wear.

12. The method according to claim 2, wherein the metallic substrate is the object of a friction system.

13. The method according to claim 3, wherein the metallic substrate is the object of a friction system.

14. The method according to claim 4, wherein the metallic substrate is the object of a friction system.

15. The method according to claim 2, wherein the metallic substrate is a cylinder working path or a bearing.

16. The method according to claim 3, wherein the metallic substrate is a cylinder working path or a bearing.

17. The method according to claim 4, wherein the metallic substrate is a cylinder working path or a bearing.

18. A layer obtainable by a method according to claim 2.

19. A metallic substrate having a coating produced according to claim 2.

20. A metallic substrate having a layer according to claim 7.
